(19) United States
(12) Patent Application Publication
(10) Pub. No.: US 2023/0385433 A1
(43) Pub. Date: Nov. 30, 2023

(54) Visual access code to a service

(71) Applicant: Orange, Issy-Les-Moulineaux (FR)

(72) Inventors: Franck Weens, Chatillon Cedex (FR); Catherine Ramus, Chatillon Cedex (FR); Camille Dauhut, Chatillon Cedex (FR)

(21) Appl. No.: 18/325,517

(22) Filed: May 30, 2023

(30) Foreign Application Priority Data
May 31, 2022 (FR) 2205245

(51) Int. Cl. G06F 21/62; G06T 7/70

(52) U.S. Cl. CPC G06F 21/62; G06T 7/70; G06F 2221/2141

(57) ABSTRACT

A method and device for verification of an access code for a service, wherein the access code is at least one object type to be recognized by the device. The method includes: obtaining data from at least one image comprising at least one object; making use of an artificial intelligence to recognize an object type in the image data; and in the event that the object type is recognized, giving access to the service.

### TECHNICAL FIELD

This disclosure relates to the field of access security for a service.

### PRIOR ART

Secure access to a service most often requires entering a password composed of a sequence of characters entered on a keyboard. These passwords are not always secure due to their simplicity. For example, they have to be changed regularly, which sometimes leads to user confusion.

### SUMMARY

This disclosure improves the situation.

A method is proposed, implemented by a computing device, for verifying an access code to a service, wherein the access code is at least one object type to be recognized by the device, the method comprising:
obtaining data from at least one image comprising at least one object,
searching, by computer recognition, for at least one object type in said image data, and
in the event that the object type is detected in said image data, providing access to the service.

Verification of a visual code in order to access a service is thus proposed. For example, in some embodiments, the object type may be initially chosen by a user, then that object type is presented to a camera along with other object types, and the computer recognition can then search for the presence of the object type previously chosen by the user, which triggers access to the service requested by the user.

“Object type” is understood here as not necessarily meaning strictly the same object that the user had previously chosen, but the same object type (for example a banana, a pen, or the like). It is thus sufficient for the user to show, for example, any banana or any pen to the camera during the computer recognition step in order for this object type to be detected, which gives access to the service.

For the computer recognition, shape recognition may be used for example (possibly accompanied by color recognition). Thus, a curved oblong shape that is yellow in color can be recognized as a banana for example, while an elongated shape within a range of grays can be identified as a pen.

In another embodiment, for example, the aforementioned search by computer recognition can make use of artificial intelligence to recognize an object type in the image data.

This artificial intelligence can be initially programmed to recognize a plurality of different object types (for example a banana, an apple, a pen, a smartphone, etc., as will be seen in examples further below particularly with reference to FIG. 1). A training phase can consist of showing several different images of the same object type, such as a banana, in different lengths, sizes, shades of color, lighting, etc. For a plurality of training images, the artificial intelligence is informed for each image that this represents the same object type. If the number of training images is sufficient, the artificial intelligence can then be sufficiently robust to recognize an object type as a banana regardless of its exact shape, exact color, lighting conditions, etc. This artificial intelligence therefore does not recognize a specific object as such, but an object type.

The artificial intelligence can be programmed in particular to recognize different object types. More generally, the aforementioned computer recognition can be configured to recognize different object types.

It is thus possible to arrange different object types in an image so that the presence of at least one

of these object types is verified, or of each of these object types, in order to give access to the requested service.

Thus, in one embodiment, the image data can include a plurality of objects, and the method can further comprise:
in the event that each object type is detected, each corresponding to an object in the image data, giving access to the service.

In an embodiment where the image data include this plurality of objects in a same image plane, the access code can comprise, in addition to the object types to be detected in a same image plane, a positioning to be detected for each object type in the image plane.

FIG. 1 illustrates such an implementation, where for example the banana is at the top right, the book at the top left, the pen at the bottom in the middle, etc. The captured image can then be subdivided into sectors in order to search for an expected object type, for example in each sector.

The search for the positioning of an object type in the image plane can also be implemented when the image data comprise a single object or only a single object type is to be searched for in the image. For example, the positioning of a banana at the top left of the image can be searched for.

The access code can comprise, in addition to the positionings to be detected for each object type in the image plane, an angular orientation in the positioning of at least one of these objects, to be detected in the image plane.

For example, the pen at the bottom middle of FIG. 1 may have to be recognized as a object type such as a pen, in a sector at the bottom middle of the image, and in a particular angular orientation in relation to the rest of the image, for example relative to the horizontal or vertical of the image plane.

In one embodiment, the image data can include an image plane of a desk comprising at least one item among a keyboard, a (computer) mouse, a cup, a pen, a sheet of paper, a smartphone.

Such an implementation can find applications in office computing in particular, for example to open up access to a computer.

In other embodiments, the image data can include an image plane of part of a room (for example a wall with hanging objects) or an item of furniture in the room.

In a complementary or alternative embodiment to the presentation of different objects in a same

image, the image data can include a succession of images each including at least one object differing from one image to the next in said succession. In such an embodiment, the access code can then comprise the different object types to be detected in the successive images.

For example, the access code can comprise the object types to be detected in an order corresponding to the successive images.

It is thus possible to successively present different object types to a camera which captures a sequence of images, and the access code can consist of recognizing these different object types then presented in the same order as this sequence.

According to another aspect, a computer program is provided comprising instructions for implementing all or part of a method as defined herein when the program is executed by a processor.

According to another aspect, a non-transitory, computer-readable storage medium is provided on which such a program is stored.

According to another aspect, a computing device is provided comprising a processing circuit configured to implement computer recognition of at least one object type in image data, in order to carry out the method as defined herein.

This computing device can comprise a communication interface for obtaining the image data and transmitting access code validation data. In such an embodiment, this device can for example take the form of a server receiving the image data captured by the camera of a remote device.

Alternatively, the computing device can comprise a camera connected to the processing circuit in order to obtain this image data (and for example to carry out locally the storing and subsequent verification of the access code). In such an embodiment, the computing device can be a terminal such as a smartphone, computer, tablet, or the like.

Said camera can be mounted in the device so as to be oriented downwards (for example to capture an image of a desktop), in readiness for implementing the method in an office application as presented below. Such an embodiment also has the advantage of searching for the object types on a neutral background such as a desktop, thus using an overhead camera, for example, aimed at this neutral background.

### BRIEF DESCRIPTION OF DRAWINGS

Other features, details, and advantages will become apparent upon reading the detailed description below, and upon analyzing the appended drawings, in which:

FIG. 1 shows an example of a visual access code to be recognized in a same image plane.

FIG. 2 shows an example of an image plane that does not match the visual code in FIG. 1 and results in a failure to access the requested service.

FIG. 3 shows another example of a visual access code, composed of a sequence of images in which each object type is successively to be recognized.

FIG. 4 shows an example of an image sequence that does not match the visual code in FIG. 3 and results in a failure to access the requested service because some of the object types do not match the code.

FIG. 5 shows an example of an image sequence that does not match the visual code in FIG. 3 and results in a failure to access the requested service because the order of appearance of some of the object types does not match the sequence in the visual code.

FIG. 6 shows an embodiment of a device for implementing the method defined above.

FIG. 7 shows an example of steps of a method of the type defined above.

### DESCRIPTION OF EMBODIMENTS

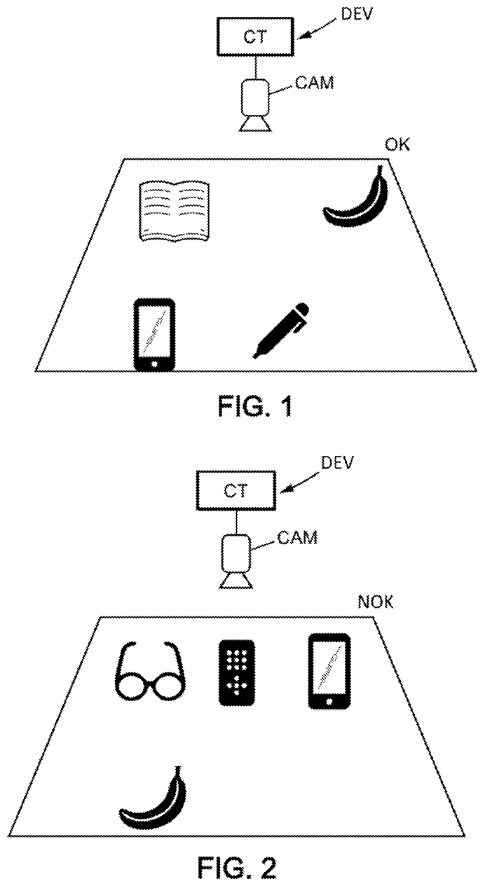

Reference is now made to FIG. 1 illustrating an embodiment in which a computing device, equipped with a camera and a processing circuit, implements computer recognition (for example by artificial intelligence) of at least:
the object types present in the field of the camera (a banana, a book, a pen, a smartphone, in the example illustrated in FIG. 1), and
a positioning of these objects in the image (the banana at the top right, the book at the top left, etc.).

The choice of these different object types and their positioning are decided beforehand by the user as the “access code”. This access code consisting of these predefined object types arranged in a specific way in a current image must then be recognized by the device in order to give the user access to a requested service. Thus, in the example illustrated in FIG. 1, processing circuit CT of device DEV must recognize for example in the image captured by camera CAM:
a banana in a top right portion of the image,
a book or printed sheets of paper in a top left portion of the image,
a smartphone in a bottom left portion of the image,
a pen in a bottom central portion of the image.

Camera CAM can be fixed for example to a computer screen in order to capture within its field the images of a desk top on which these various objects are arranged. The position of the camera is preferably fixed between the preliminary phase of recording the access code chosen by the user, and the subsequent phase of recognizing the object types placed by the user in order to validate the access code. The field of the camera is thus substantially the same between these two phases. For example, this position of the camera can be abutted against the screen in order to capture images downwards as illustrated in FIG. 1. Alternatively, the camera can capture a wide field, and the positioning of objects can be recognized by the relative positioning of objects in relation to each other (for example the banana to the right of the book and above the pen).

In the preliminary phase of recording the access code, in the case of using artificial intelligence,

the latter can recognize in an image captured by the camera, depending on the user's choice of object types and their placements (positions and possibly orientations):
an object type such as a banana in a top right portion of the image,
an object type such as a book (or printed sheets of paper) in a top left portion of the image,
an object type such as a smartphone in a bottom left portion of the image,
an object type such as a pen in a bottom central portion of the image.

Processing circuit CT records this information about the object types and their relative positioning (or absolute positioning such as “banana in a top right quarter of the image”, “book in a top left quarter of the image” , etc.), as an access code to be recognized in a future use.

Here, the device specifically recognizes one or more object “types” and not these objects as such.

For example, an object such as a banana is unique. The use here of a computer search (by pattern recognition or by making use of an artificial intelligence) then consists of the simple recognition of any banana, as compared to an apple or some other object type.

For example, a conventional artificial intelligence can be programmed to learn to recognize different object types (smartphones, cups of coffee or tea, pens, books or printed sheets, various fruits (such as bananas, apples, and/or the like)). Then, after this training phase, the artificial intelligence can recognize, in the image composed by the user, these different object types in an image captured by the camera. Indeed, during the preliminary phase of recording the access code, the processing circuit can store this information data (recognized object types and positions) as an access code to be recognized later on during a phase of verifying the validity of an access code, described now with reference to FIG. 2. The access code can comprise, in addition to the positioning in each image sector where each object type is to be recognized, an angular orientation in the positioning of at least one of these objects (for example the orientation of the banana, or pen, or of the lines printed on sheets of paper, or the like). For example, the pen at the bottom middle of FIG. 1 may need to be recognized as a object type such as a pen, in a sector at the bottom middle of the image, and in a particular angular orientation, for example relative to the horizontal or vertical of the image plane. This information is stored as the access code data composed of these object types and their positionings/orientations.

In FIG. 2, if some of the object types of the access code are no longer found in the captured image (for example here the book and the pen) and/or if the object types of the access code found by the artificial intelligence are not at the expected positions, then the access code presented to the processing circuit is not verified as being valid and access is not granted to the service requested by the user.

As explained above, the use of artificial intelligence serves to recognize object types and not the objects as such. Even so, the user already can have a wide choice among a plurality of different object types to be recognized. Thus, in one particular embodiment, verifying the validity of the access code can consist simply of recognizing a single object type (chosen beforehand by the user) in an image, independently for example of the positioning of this object in the image. In this embodiment, in which a single object is used, the processing circuit is configured to recognize the object type. In another embodiment, the circuit can be configured to recognize the object type and its positioning in an image (this image can be an image of the office or an image of any other part of a room).

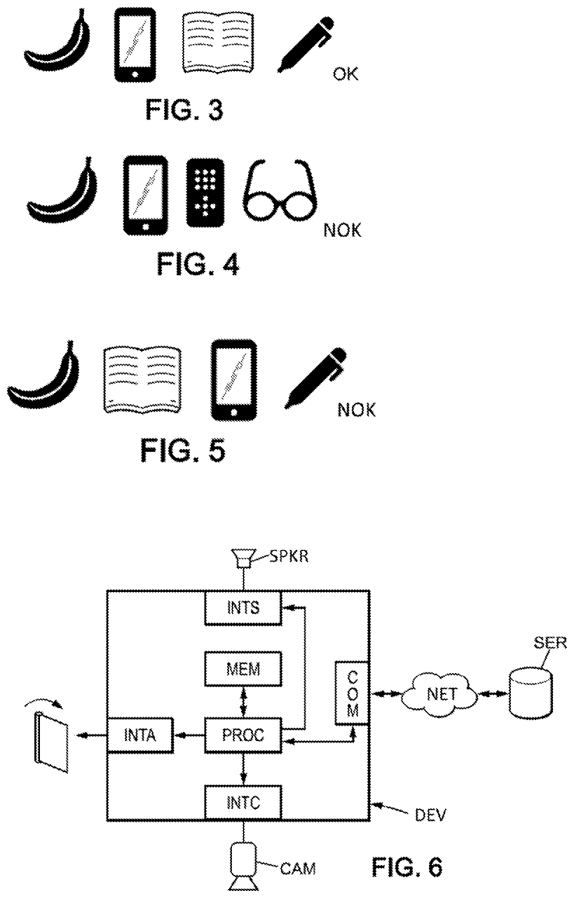

In addition, provision may be made to successively present several object types to the camera so that the processing circuit records these different object types (in the order of their successive presentations to the camera, or not). Thus, with reference to FIGS. 3 and 4, if objects of other types are presented to the camera during the phase of verifying the validity of the access code, the access code is not confirmed.

With reference to FIG. 5 illustrating one particular embodiment, if the order in which the object types are presented does not correspond to the order previously recorded, the access code is not validated. Thus, in this embodiment of FIG. 5, several different object types are sequentially presented to the camera and, in order to verify the validity of the code, the device must then recognize these object types in a particular sequence corresponding to the one previously recorded (the banana first, then the smartphone, then the book, then the pen). In this embodiment, the objects whose types are to be recognized are therefore not necessarily in the same image simultaneously as was illustrated in FIG. 1.

Thus, the use of everyday objects, possibly positioned correctly with the space (FIGS. 1 and 2), and usually available to a user (typically on his or her desk), facilitates the entry of an access code by this user and at the same time improves access security (without relying on a sequence of characters as the usual password). This access code can indeed be considered as “strong” when it uses several different concepts (different object types), whereas a conventional password generally only refers to a single concept (a single word or a single logical sequence of words, possibly embellished with numerals and/or special characters) or else the sequence of characters which corresponds to the password is random and therefore very difficult for a user to remember.

The user then only needs to position different objects within the field of the camera. Artificial intelligence makes it possible to recognize the objects and in particular to identify the object types and possibly their positions in the image.

The device can be used with a remote server, the information (object type and positions) being sent from the processing circuit to the remote server for comparison (to the reference access code previously stored on the server). The reference access code that is stored on the server can be generated in various ways.

In a first embodiment, it is captured by the camera and the image data thus captured is sent to the server which makes use of artificial intelligence to recognize the different object types and their respective positions in the captured image and/or in the sequence of captured images.

In a second embodiment, the server can offer a user an access code entry service via a home page of a website where the user is able to tick different types of everyday objects (cup, computer keyboard and/or mouse, pen, smartphone, sheet of paper, etc.). The user makes a selection in an order or positioning that he or she chooses online and this information is stored on the server. Next, the user presents object types corresponding to those previously selected online (possibly in an order and/or a positioning that the user has previously chosen), and the server's artificial intelligence recognizes these object types and thus determines whether they correspond to those previously selected by the user.

If the device is used locally (without involving a server), this information is compared with information previously stored in a memory of the device (this memory locally storing information data about the object types and possibly the positionings and/or order of appearance in a sequence, corresponding to the access code which is to be verified later on).

The embodiment presented above can be used in an office application, for example to open access to a desktop computer.

It can also be used to locally open a door reliably and discreetly, such as a safe door. For example, the user can place objects in front of the camera to form an image corresponding to a visual access code. In training mode, the device can be configured to confirm that recording the access code has started by emitting an audio or visual signal, for example via a human-machine interface. The user has for example a few tens of seconds to place the objects of his or her choice within the field of the camera. Next, the device can be configured to confirm the recording via audio or visual feedback by managing the aforementioned human-machine interface. After this phase of recording the access code, in a subsequent phase of verifying the code, the user wishing to access a resource (for example open a safe or deactivate an alarm system) places objects of his or her choice in front of the camera and enters a safe-opening or alarm-shutoff command. If the visual code is correct, the device can be configured to give an order to an actuator, for example to open a door, and manages the human- machine interface to emit an audible or visual signal indicating that the access code is correct. If the code is incorrect, no feedback is provided so as not to give any indications about the access code.

Referring now to FIG. 6, a device DEV for implementing the above method can comprise in its processing circuit at least one memory MEM and one processor PROC. Memory MEM can store in particular instruction codes of a computer program for implementing the method, as well as for example previously stored access code information data. Processor PROC can access memory MEM in particular to execute the aforementioned instructions. Device DEV may further comprise aforementioned camera CAM, which is connected to processor PROC via a video interface INTC. Device DEV may further comprise a communication interface COM with a remote server SER (via a communication network NET), for example in the case presented above where registration and verification of the access code are carried out on server SER. Processor PROC can also drive a human-machine interface INTS to play for example various sound signals via a loudspeaker HP in order to inform the user of various successes in entering and/or validating the access code. Processor PROC can also drive an interface INTA for controlling the opening of a door in this exemplary embodiment.

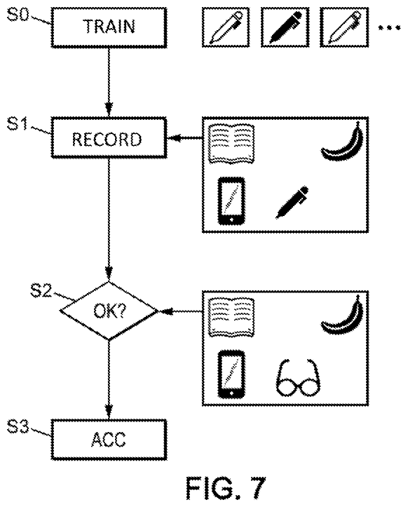

Illustrated in FIG. 7 are different steps of a method of the type described above according to one exemplary embodiment. A first step SO can consist of teaching the artificial intelligence to recognize different object types. For example, here, images of different pens are presented to the artificial intelligence to teach it to recognize a object type such as a pen in general. Then in step S1, in order to record a visual access code, an image (or several sequential images) of different objects is presented to the artificial intelligence to have it recognize the object types appearing in each image. The information about these object types (and possibly their positioning) is stored in memory and constitutes the visual access code. In a next step S2, at least one image (or a sequence) is presented containing different object types arranged by the user, and the device recognizes or does not recognize these different object types in order to validate or not validate the access code. If this test of step S2 is positive, access to the requested service can be provided (step S3).

Of course the above step SO in particular is optional. Typically, there are already pre-programmed modules on the market that make use of an artificial intelligence capable of recognizing different object types. Such a module can be implemented with device DEV or with a server such as said server SER, or with another entity capable of communicating with device DEV.

More generally, the invention is not limited to the embodiments presented above by way of example; it extends to other variants.

For example, the visual code can correspond to a particular object type to be recognized among other objects in an image, this particular object type needing for example to be placed in a predefined area of the image. In this embodiment, not all object types appearing in the image are necessarily to be recognized, but at least one of them must be recognized and access is only given if this recognized object type is present with other objects.

1. A method implemented by a computing device, for verifying an access code to a service, wherein the access code comprises at least one object type to be recognized by the device, the method comprising:
obtaining data from at least one image comprising at least one object;
searching, by computer recognition, for at least one object type in said image data; and
in the event that the object type is detected in said image data, providing access to the service.

2. The method according to claim 1, wherein the searching for the object type by computer recognition comprises:
making use of artificial intelligence to recognize an object type in said image data.

3. The method according to claim 1, wherein the image data includes a plurality of objects, and the method further comprises:
in the event that each object type is detected, each corresponding to an object in the image data, giving access to the service.

4. The method according to claim 3, wherein the image data include said plurality of objects in a same image plane, and wherein the access code comprises, in addition to the object types to be detected in a same image plane, a positioning to be detected for each object type in the image plane.

5. The method according to claim 4, wherein the access code comprises, in addition to the positionings to be detected for each object type in the image plane, an angular orientation in the positioning of at least one of said objects, to be detected in the image plane.

6. The method according to claim 4, wherein the image data include an image plane of a desk comprising at least one item among a keyboard, a mouse, a cup, a pen, a sheet of paper, a smartphone.

7. The method according to claim 3, wherein the image data include a succession of images each including at least one object differing from one image to the next in said succession, and wherein the access code comprises the object types to be detected in the successive images.

8. The method according to claim 7, wherein the access code comprises the object types to be detected in an order corresponding to the successive images.

9. A non-transitory computer-readable storage medium storing instructions of a computer program for implementing a method for verifying an access code to a service, when such instructions are executed by a processor, wherein the access code comprises at least one object type to be recognized by the device, and wherein the method comprises:
obtaining data from at least one image comprising at least one object;
searching, by computer recognition, for at least one object type in said image data; and
in the event that the object type is detected in said image data, providing access to the service.

10. A computing device comprising:
a processing circuit configured to implement computer recognition of at least one object type in image data, in order to carry a method for verifying an access code to a service, wherein the access code comprises at least one object type to be recognized by the device, the method comprising:
obtaining data from at least one image comprising at least one object;
searching, by computer recognition, for the at least one object type in said image data;
and in the event that the object type is detected in said image data, providing access to the service.

11. The computing device according to claim 10, comprising a communication interface for obtaining said image data and transmitting access code validation data.

12. The computing device according to claim 10, comprising a camera connected to the processing circuit in order to obtain said image data.

13. The computing device according to claim 12, wherein the camera is mounted in the device so as to be oriented downwards, in readiness for implementing the method wherein the image data includes an image plane of a desk comprising at least one item among a keyboard, a mouse, a cup, a pen, a sheet of paper, a smartphone.
